(19) United States
(12) Patent Application Publication
(10) Pub. No.: US 2012/0081744 A1
(43) Pub. Date: Apr. 5, 2012

(54) PRINTING SYSTEM, PRINTING MANAGEMENT APPARATUS, PRINTING MANAGEMENT PROGRAM, AND METHOD OF MANAGING PRINTING PROCESS

(75) Inventor: Masatoshi KADOTA, Takahama-shi (JP)

(73) Assignee: BROTHER KOGYO KABUSHIKI KAISHA, Nagoya-shi (JP)

(21) Appl. No.: 13/247,916

(22) Filed: Sep. 28, 2011

(30) Foreign Application Priority Data
Sep. 30, 2010 (JP) 2010-221447

(51) Int. Cl. G06K 15/02

(52) U.S. Cl. 358/1.15

(57) ABSTRACT

A printing system includes: a client; at least one printer; a server; and a management device. The client is transmits a permission request to the management device. The management device determines a number of jobs in a print queue, calculates a comparison value by adding one to the number of jobs in the print queue, and compares a predetermined value to the comparison value upon receipt of the permission request. The management device transmits a utilization permission to the client when the comparison value is less than or equal to the predetermined value. The client transmits a job comprising image data to the server when the client receives the utilization permission, and the server generates printing data based on the image data when the server receives the job and transmits the printing data to the at least one printer.

### CROSS REFERENCE TO RELATED APPLICATION

This application claims priority from Japanese Patent Application No. 2010-221447 filed on Sep. 30, 2010. The entire content of the priority application is incorporated herein by reference.

### TECHNICAL FIELD

The present invention relates to a technique of operating, from a client terminal, a peripheral device connected to a network.

### BACKGROUND

Printing systems in which a plurality of client terminals and a plurality of printing apparatuses are connected to a network including a server apparatus have become widespread with the improvement of network technologies. Such a printing system is configured so that print data can be generated by a server apparatus. That is, in this printing system, a client terminal first transmits a print job to the server apparatus before a printing apparatus prints the print job. Subsequently, the server apparatus adds a print service, e.g., generates print data based on the received print job and transmits the print data to the printing apparatus. Then, the printing apparatus prints an image based on the received print data.

### SUMMARY

In such a printing system, when many print jobs are transmitted to the server apparatus in a concentrated manner, the server apparatus may be overburdened and may not process the print jobs quickly enough. Thus, the overburdened server apparatus may operate slowly or stop. In addition, the server apparatus may become a target of a cyberattack in which a malicious user intentionally transmits a large number of print jobs to the server apparatus. Such cyber attacks may readily occur in the foregoing printing system where many unspecified client terminals may be connected to a network.

Accordingly, a technique for reducing a processing load on a server apparatus in a printing system where a print service is added by the server apparatus will be disclosed herein.

A printing system disclosed herein may comprise a client; at least one printer; a server; and a management device. The client may be configured to transmit a permission request to the management device. The management device may be configured to determine a number of jobs in a print queue, calculate a comparison value by adding one to the number of jobs in the print queue, and compare a predetermined value to the comparison value upon receipt of the permission request. The management device may be configured to transmit a utilization permission to the client when the comparison value is less than or equal to the predetermined value. The client may be configured to transmit a job comprising image data to the server when the client receives the utilization permission. The server may be configured to generate printing data based on the image data when the server receives the job and to transmit the printing data to the at least one printer.

A management device disclosed herein may comprise a receiver, a counter, a calculator, a comparator, and a transmitting device. The receiver may be configured to receive a permission request from a client. The counter may be configured to determine a number of print jobs in a print queue. The calculator may be configured to calculate a comparison value by adding one to the number of print jobs in the print queue. The comparator may be configured to compare a predetermined value to the comparison value. The transmitting device may be configured to transmit a utilization permission to a client when the comparison value is less than or equal to the predetermined value to permit the client to transmit a job to a server, and, when the comparison value is greater than the predetermined value, to not permit the client to transmit the job to the server.

A method of managing a printing process disclosed herein may comprise steps for managing the printing process. The method may comprise a step of transmitting a permission request from a client to a management device. The method may comprise a step of determining a number of print jobs in a print queue. The method may comprise a step of calculating a comparison value by adding one to the number of print jobs in the print queue. The method may comprise a step of comparing a predetermined value to the comparison value. The method may comprise a step of transmitting a utilization permission from the management device to the client when the comparison value is less than or equal to the predetermined value. The method may comprise a step of transmitting a job comprising image data from the client to a server when the client receives the utilization permission from the management device. The method may comprise a step of generating printing data in the server based on the image data when the server receives the job from the client. The method may comprise a step of transmitting the printing data from the server to a printer. The method may comprise a step of printing the printing data.

Another method of managing a printing process disclosed herein may comprise steps for managing the printing process. The method may comprise a step of receiving a permission request from a client. The method may comprise a step of determining a number of print jobs in a print queue. The method may comprise a step of calculating a comparison value by adding one to the number of print jobs in the print queue. The method may comprise a step of comparing a predetermined value to the comparison value. The method may comprise a step of transmitting a utilization permission to a client when the comparison value is less than or equal to the predetermined value to permit the client to transmit a job to a server.

A non-transitory, computer-readable medium disclosed herein may comprise operating instructions to perform several steps. The non-transitory, computer-readable medium may comprise an operating instruction to perform a step of receiving a permission request from a client. The non-transitory, computer-readable medium may comprise an operating instruction to perform a step of determining a number of print jobs in a print queue. The non-transitory, computer-readable medium may comprise an operating instruction to perform a step of calculating a comparison value by adding one to the number of print jobs in the print queue. The non-transitory, computer-readable medium may comprise an operating instruction to perform a step of comparing a predetermined value to the comparison value. The non-transitory, computer-readable medium may comprise an operating instruction to perform a step of transmitting a utilization permission to a client when the comparison value is less than or equal to the predetermined value to permit the client to transmit a job to a server.

The above-described technique may be realized in various modes, such as a printing management apparatus and a printing management system.

According to the present invention, print jobs permitted by the printing management unit are transmitted to the server apparatus. This may prevent transmission of print jobs to the server apparatus exceeding the server apparatus' allowance in one period, thereby reducing the processing load on the server apparatus.

Other objects, features, and advantages will be apparent to persons of ordinary skill in the art from the following detailed description of the invention and the accompanying drawings.

### BRIEF DESCRIPTION OF THE DRAWINGS

FIG. 1 is a block diagram of a printing system according to an embodiment;

FIG. 2 is a flowchart illustrating a process performed by a PC in a printing process according to the embodiment depicted in FIG. 1;

FIG. 3 is a flowchart illustrating a process performed by a printer in the printing process according to the embodiment depicted in FIG. 1;

FIG. 4 is a flowchart illustrating a process performed by a server apparatus in the printing process according to the embodiment depicted in FIG. 1;

FIG. 5 is a flowchart illustrating a print data generation process performed in the printing process according to the embodiment depicted in FIG. 1;

FIG. 6 is a diagram illustrating time-series data transmission in the printing process according to the embodiment depicted in FIG. 1;

FIG. 7 is a flowchart illustrating an abnormality monitoring process according to the embodiment depicted in FIG. 1;

FIG. 8 is a block diagram of a printing system according to another embodiment;

FIG. 9 is a flowchart illustrating a process performed by a printing management apparatus in a printing process according to the other embodiment depicted in FIG. 8;

FIG. 10 is a flowchart illustrating an authentication process according to still another embodiment; and

FIG. 11 is a flowchart illustrating an authentication process according to yet another embodiment.

### DETAILED DESCRIPTION

### Embodiment

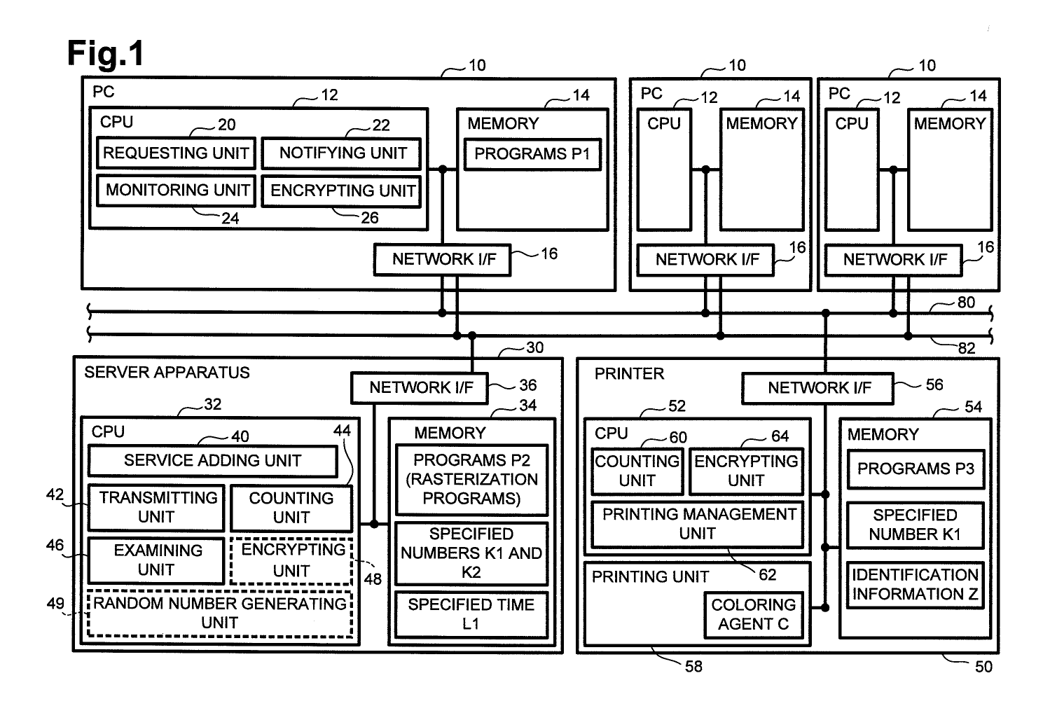

An embodiment will be described with reference to FIGS. 1 through 7.

1. Configuration of System

The system illustrated in FIG. 1 may comprise a plurality of personal computers (an example of client terminals, hereinafter referred to as “PCs”) 10, a server apparatus 30, and a printer (printing apparatus) 50.

Each of the PCs 10 may comprise a central processing unit (hereinafter referred to as “CPU”) 12, a memory 14 (which may comprise a ROM, a RAM, and a hard disk), and a network interface 16.

The memory 14 may store a plurality of programs P1. In accordance with the programs (printer driver) P1 read from the memory 14, the CPU 12, which may function as a requesting unit 20, a notifying unit 22, a monitoring unit 24, an encrypting unit 26, and the like, controls the PC 10. The CPU 12 may also control communication performed with the server apparatus 30 and so forth.

The network interface 16 may be connected to a communication line 80 of a local area network (“LAN”) which may comprise an intranet, for example. The printer 50 may be connected to the communication line 80 so that the PC 10 may perform data communication with or transmit a process request to the printer 50 via the network interface 16. Furthermore, the network interface 16 may be connected to a communication line 82 of a wide area network (“WAN”), such as the Internet. The PC 10 may be connected to the server apparatus 30 via the communication line 82. The connection with the foregoing LAN and WAN may be realized by a direct connection using dedicated lines or by a connection using wireless communication.

Next, the server apparatus 30 will be described. The server apparatus 30 may comprise a CPU 32, a memory 34, and a network interface 36.

The memory 34 may store a plurality of programs P2. The CPU 32 may, in accordance with the programs P2 read from the memory 34, function as a service adding unit 40, a transmitting unit 42, a counting unit 44, an examining unit 46, and the like; control the server apparatus 30; and control communication performed with the PCs 10.

The network interface 36 may be connected to the communication line 82, and may perform data communication and input/output of a process request with the PCs 10.

As illustrated in FIG. 1, the programs P2 stored in the memory 34 may comprise rasterization programs R for the printer 50. The rasterization programs R may be used for generating print data that may be used in the printer 50 based on a print job transmitted from the PC 10 (an example of a print service) and that may correspond to the individual models of printers. When a user performs printing using the system according to this embodiment, a print job may be transmitted from the PC 10 to the server apparatus 30, and then print data generated by the server apparatus 30 may be transmitted to the printer 50.

In the server apparatus 30, the number of print jobs received from the PCs 10 may be managed by the CPU 32. Specifically, the CPU 32 may count the number of print jobs received from the PCs 10. The server apparatus 30 may not accept a print job from any of the PCs 10 if the counted number is a certain number or more. The number of print jobs received by the server apparatus 30 may be managed in this way.

Next, the printer 50 will be described. The printer 50 may comprise a CPU 52, a memory 54, a network interface 56, and a printing unit 58.

The memory 54 may store a plurality of programs P3. In accordance with the programs P3 read from the memory 54, the CPU 52 may function as a counting unit 60, a printing management unit 62, an encrypting unit 64, and the like; may control the printer 50; and may control communication performed with the PCs 10. Also, the memory 54 may store identification information Z (an example of specified data) that is encrypted by the CPU 52 functioning as the encrypting unit 64.

The network interface 56 may be connected to the communication line 80, and may perform data communication and input/output of a process request with the PCs 10.

The printing unit 58 may print an image based on print data received from the server apparatus 30. The printing unit 58 may comprise a transport unit that transports a printing medium and an image forming unit that forms an image on the printing medium. The image forming unit may comprise a toner cartridge filled with a coloring agent C. The configuration of the printing unit 58 according to this embodiment may be equivalent to the configuration of the printing unit of a typical printer. Thus, the detailed description of the printing unit 58 is omitted.

In the printing unit 58, the number of pieces of print data received by the CPU 52 from the server apparatus 30 may be managed. Specifically, the CPU 52 may count the number of print jobs transmitted from the PCs 10 to the server apparatus 30, and may grant permission for generating print data to print jobs (an example of utilization permission) if the number of the print jobs is a certain number or less. Thus, the CPU 52 may thereby manage the number of pieces of print data received by the printing unit 58.

The CPU 52 may obtain the status of the printing unit 58. Specifically, the CPU 52 may obtain the residual amount of the recording medium in a tray and the residual amount of the coloring agent C in the toner cartridge. Also, the CPU 52 may transmit an acquisition result of the status of the printing unit 58 to the PCs 10. Accordingly, the CPUs 12 of the PCs 10 that receive the acquisition result may monitor whether or not the printing unit 58 has an abnormality using the acquisition result. Also, the CPU 52 may transmit the status of a permission queue (described below) to the PCs 10 together with the acquisition result of the status of the printing unit 58.

2. Printing Process

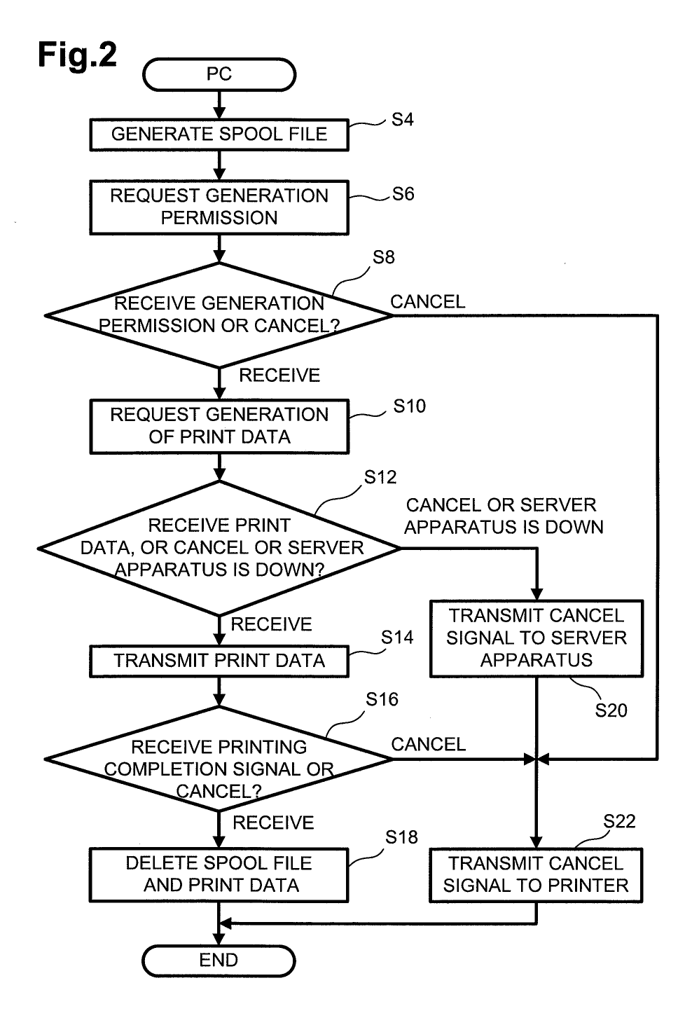

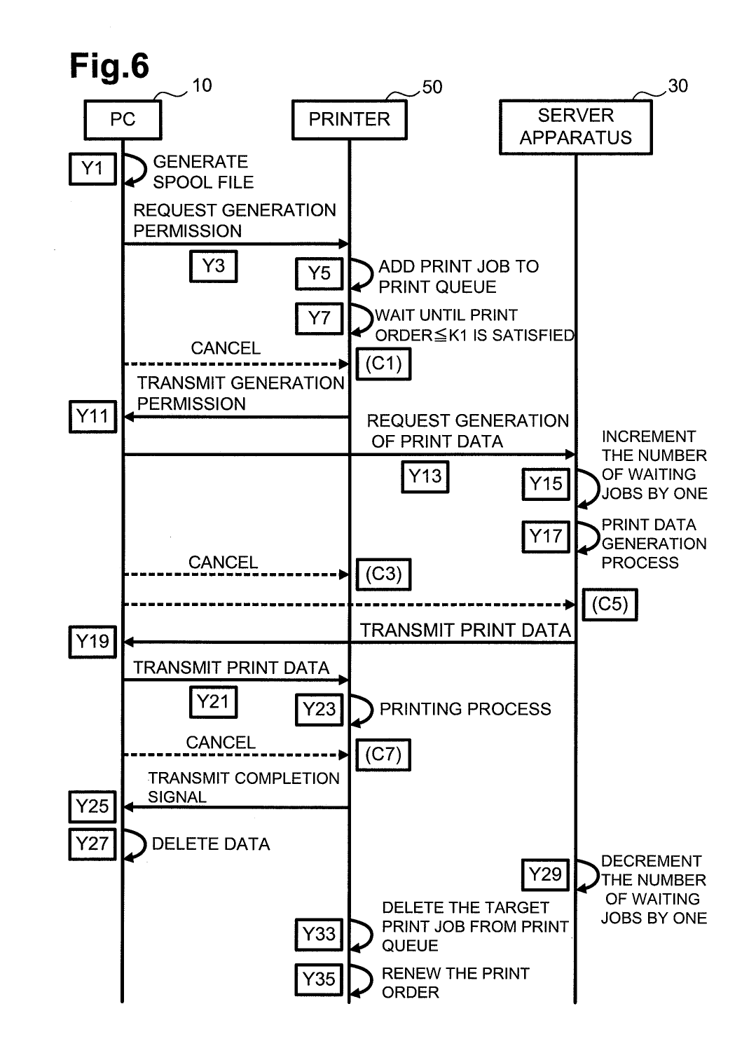

The processes performed by the individual apparatuses in a printing process will be described below. FIGS. 2 through 5 illustrate flowcharts of the processes performed by the PC 10, the printer 50, and the server apparatus 30; and FIG. 6 illustrates the state of transmission of instructions, data, and the like in the processes.

Process Performed in PC

First, the process performed by the CPU 12 of the PC will be described. The process may be performed in accordance with the programs P1 stored in the memory 14. Also, the process may be started when a print job is input to the PC 10 by a user.

As illustrated in FIG. 2, the CPU 12 may generate a spool file from image data comprised in a print job (S4 in FIG. 2, Y1 in FIG. 6), may temporarily store the spool file in the memory 14, and may function as the requesting unit 20 (first requesting unit) which may request the printer 50 to permit generation of print data (S6 in FIG. 2, Y3 in FIG. 6).

Here, the spool file may be intermediate data that may be generated for generating print data suitable for the printer 50 from the image data comprised in the print job. The spool file may be generated by the PC 10, thereby reducing the processing load on the server apparatus 30, which may operate on the basis of the rasterization programs R, when the server apparatus 30 generates print data.

If the CPU 12 receives a permission from the printer 50 in response to the request for permission for generating print data (“receive” in S8 in FIG. 2, Y11 in FIG. 6), the CPU 12 may function as the requesting unit 20 (second requesting unit) which may request the server apparatus 30 to generate print data (S10 in FIG. 2, Y13 in FIG. 6). Alternatively, if an instruction to cancel the print job is input by the user before receiving a permission from the printer 50 (“cancel” in S8 in FIG. 2), the CPU 12 may function as the notifying unit 22 (first notifying unit) which may transmit a cancel signal to the printer 50 (S22 in FIG. 2, C1 in FIG. 6)

If the CPU 12 receives print data from the server apparatus 30 in response to the request for generating print data (“receive” in S12 in FIG. 2, Y19 in FIG. 6), the CPU 12 may temporarily store the print data in the memory 14, transmit the print data to the printer 50 (S14 in FIG. 2, Y21 in FIG. 6), and request the printer 50 to print an image on the basis of the print data. Alternatively, if an instruction to cancel the print job is input from the user before receiving print data from the server apparatus 30, or if the request for generating print data may not be transmitted to the server apparatus 30 (“cancel or server apparatus is down” in S12 in FIG. 2), the CPU 12 may function as the notifying unit 22 (the notifying unit 22 comprising first and second notifying units) which may transmit a cancel signal to the server apparatus 30 and the printer 50 (S20 and S22 in FIG. 2, C3 and C5 in FIG. 6).

If the CPU 12 receives a printing completion signal from the printer 50 based on the request for printing an image (“receive” in S16 in FIG. 2, Y25 in FIG. 6), the CPU 12 may delete the spool file and the print data stored in the memory 14 (S18 in FIG. 2, Y27 in FIG. 6). Accordingly, even if the user repeatedly inputs a print job using the PC 10, the CPU 12 may suppress accumulation of the spool files and print data corresponding to completed print jobs in the memory 14. Thus, a decrease in the processing speed of the PC 10 may be suppressed.

Alternatively, if a user inputs an instruction to cancel the print job before receiving a printing completion signal from the printer 50 (“cancel” in S16 in FIG. 2), the CPU 12 may function as the notifying unit (first notifying unit) 22 and transmit a cancel signal to the printer 50 (S22 in FIG. 2, C7 in FIG. 6).

Process Performed in Printer

Next, the process performed by the CPU 52 of the printer 50 will be described. This process may be repeatedly performed while the power of the printer 50 is in an ON state.

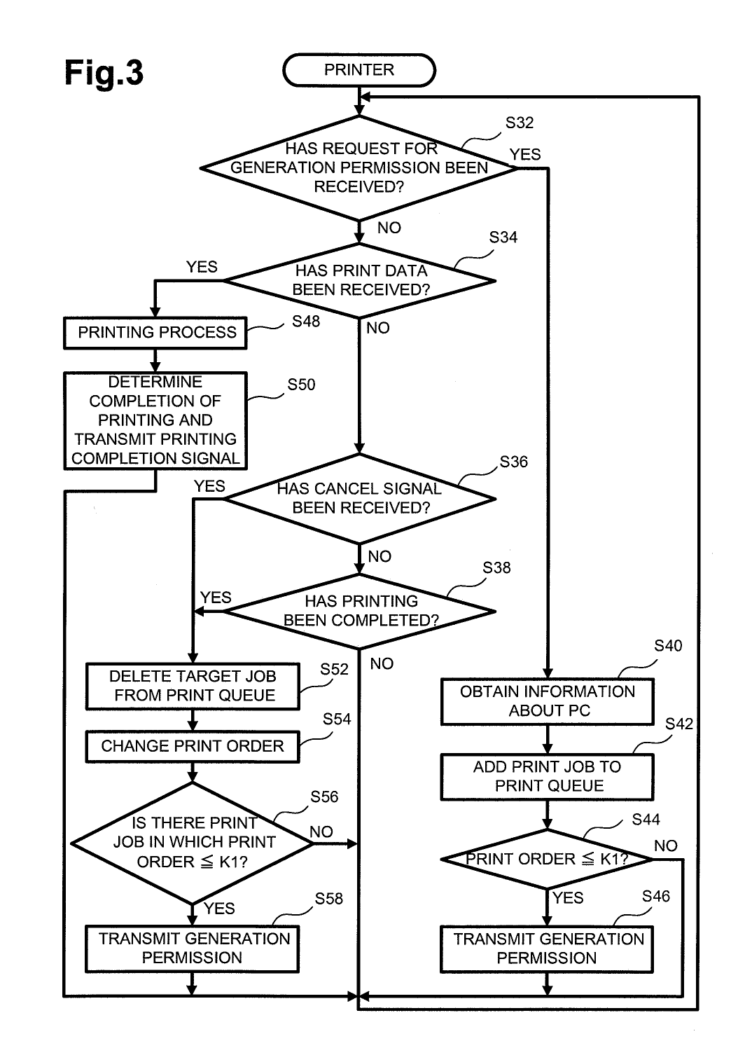

As illustrated in FIG. 3, the CPU 52 may repeatedly determines whether or not any of the following four situations has occurred (S32, S34, S36, and S38). That is, the CPU 52 may wait until any of the following four situations occur:

(1) The CPU 52 receives a request for permission to generate print data from the PC 10 (S32);

(2) The CPU 52 receives print data from the PC 10 (S34);

(3) The CPU 52 receives a cancel signal from the PC 10 (S36); or

(4) The CPU 52 Determines that Printing is Complete.

If the CPU 52 receives a request for permission to generate print data from the PC 10 (YES in S32 in FIG. 3, Y3 in FIG. 6), the CPU 52 may obtain information about the PC 10 that transmitted the request for permission to generate print data (S40 in FIG. 3). Also, the CPU 52 may function as the counting unit 60 and may add the print job to a print queue based on the received request for permission to generate print data (S42 in FIG. 3, Y5 in FIG. 6).

Here, the print queue may be a queue for setting the order of printing print data in response to the request for permission to generate print data received by the CPU 52. The print queue may comprise print jobs that have not been printed by the printing unit 58, such as print jobs for which permission to generate print data has been transmitted and print jobs for which permission to generate print data has not been transmitted. For example, where the CPU 52 sets the print order “5” to a certain print job, the CPU 52 may have four print jobs that have higher priority than the certain print job and have not been processed for printing images based thereon. Typically, the CPU 52 may set the print order of each print job based on the order in which a request is received, i.e., the print order matches the order in which a request is received. If a request indicates priority printing or the like, the print order may be set so that the requested print job may be preferentially performed before other print jobs having a print order of K1 or thereafter.

Subsequently, the CPU 52 may function as the printing management unit 62 and may compare the print order of the print job with the specified number K1 stored in the memory 54 (S44 in FIG. 3). If the print order of the print job is equal to or lower than the specified number K1 (YES in S44 in FIG. 3), the CPU 52 may transmit permission for generating print data to the PC 10 in response to the request (S46 in FIG. 3, Y11 in FIG. 6), and the process may return to S32. Alternatively, if the print order of the print job is higher than the specified number K1 (NO in S44 in FIG. 3), the CPU 52 may not transmit permission to generate print data in response to the request, and the process may return to S32. The CPU 52 may hold the request for permission to generate print data until the print order of the print job is less than or equal to K1 (Y7 in FIG. 6).

If the CPU 52 receives print data from the PC 10 (YES in S34 in FIG. 3, Y21 in FIG. 6), the CPU 52 may perform a printing process (S48 in FIG. 3, Y23 in FIG. 6). In the printing process, the CPU 52 may control the printing unit 58, thereby printing an image based on the received print data. After printing an image and ending the printing process, the CPU 52 may determine the completion of printing, transmit a printing completion signal to the PC 10 (S50 in FIG. 3, Y25 in FIG. 6), and return the process to S32.

If the CPU 52 receives a cancel signal from the PC 10 (YES in S36 in FIG. 3, C1, C3, or C7 in FIG. 6) or if the CPU 52 determines that the preceding process has completed printing (YES in S38 in FIG. 3), the CPU 52 may delete the target job from the print queue (S52 in FIG. 3, Y33 in FIG. 6). Thus, the number of print jobs for which a printing process has not yet been performed decreases by the number of deleted target jobs. Accordingly, the CPU 52 may renew the print order of the request when the CPU 52 is waiting to transmit permission to generate print data and the request has priority lower than the print order of the deleted print job (S54 in FIG. 3, Y35 in FIG. 6).

Subsequently, the CPU 52 may function as the printing management unit 62 and may compare the renewed print order with the specified number K1 (S56 in FIG. 3). If a print job exists where the renewed print order is equal to or lower than the specified number K1 (YES in S56 in FIG. 3), the CPU 52 may transmit permission to generate print data to the PC 10 (S58 in FIG. 3, Y11, in FIG. 6). Thus, printer 50 may transmit permission to generate print data for a number of print jobs equal to or fewer than the specified number K1. Also, the CPU 52 may maintain a state where permission to generate print data is not transmitted in response to the other requests.

Process Performed in Server Apparatus

Next, the process performed by the CPU 32 of the server apparatus 30 will be described. This process may be repeatedly performed while the power of the server apparatus 30 is in an ON state.

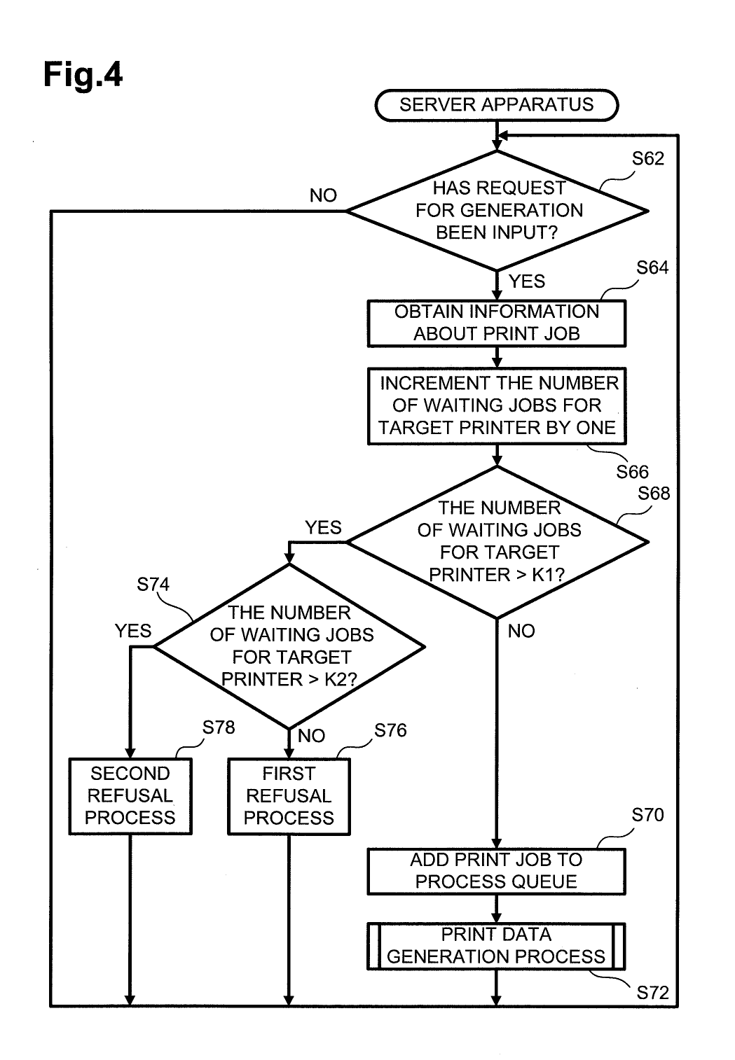

As illustrated in FIG. 4, the CPU 32 may determine whether or not a request for generating print data has been input from any of the PCs 10 via the WAN (S62 in FIG. 4). If no request is input in a certain period (NO in S62 in FIG. 4), the process may return to S62. That is, the CPU 32 may wait until a request for generating print data is input from any of the PCs 10 via the WAN.

Alternatively, if the server apparatus 30 receives a request from any of the PCs 10 in the certain period (YES in S62 in FIG. 4, Y13 in FIG. 6), the CPU 32 may obtain the information about the print job associated with the request (S64 in FIG. 4). The information about the print job may specify in advance the printer 50 for printing an image based on the print job. After obtaining the information about the print job associated with the received request, the CPU 32 may function as the counting unit 44 and increment the number of waiting jobs for the target printer 50 by one (S66 in FIG. 4, Y15 in FIG. 6).

Here, the number of waiting jobs may be the number of print jobs in which a request to generate print data is received in the server apparatus 30 or the number of print jobs in which an image based thereon has not been printed. The number of waiting jobs may be set for each printer 50 for which the server apparatus 30 generates print data. The number of print jobs for which the printer 50 transmits permission to generate print data may be limited to the specified number K1 or less. Therefore, the number of waiting jobs in the server apparatus 30 may typically be set equal to or less than the product of the specified number K1 of the printer 50 and the total number of target printers 50.

Subsequently, the CPU 32 may compare the number of waiting jobs for the target printer 50 with the specified number K1 stored in the memory 34 (S68 in FIG. 4). If the number of waiting jobs for the target printer 50 is larger than the specified number K1 (YES in S68 in FIG. 4), the CPU 32 may determine that an abnormality has occurred in the server apparatus 30. In this case, the CPU 32 may further compare the number of waiting jobs for the target printer 50 with a specified number K2, which is larger than the specified number K1 (S74 in FIG. 4).

If the number of waiting jobs for the target printer 50 is equal to or less than the specified number K2 (NO in S74 in FIG. 4), the CPU 32 may determine that a first abnormality has occurred. For example, the first abnormality may comprise following situation. When the printer 50 powers off, the printer 50 may erase the print jobs in the print queue managed by the printer 50. Thus, permission for generating print data may be excessively transmitted according to the specified number K1 when the printer 50 powers on thereafter. As a result, the number of print jobs may exceed the specified number K1, and an excessive number of print jobs may be input into the server apparatus 30. In this case, the CPU 32 may perform a first refusal process (S76 in FIG. 4) wherein CPU 32 will not accept a request from the PC 10 for a first period T1.

Alternatively, if the number of waiting jobs for the target printer 50 is larger than the specified number K2 (YES in S74 in FIG. 4), the CPU 32 may determine that a second abnormality has occurred. For example, the second abnormality may be an excessive transmission of print jobs (e.g., a cyberattack) which increases the load on the server apparatus 30. In this case, the CPU 32 may perform a second refusal process (S78 in FIG. 4) wherein CPU 32 will not accept a request from the PC 10 for a second period T2, which is longer than the first period T1.

Alternatively, if the number of waiting jobs for the target printer 50 is equal to or less than the specified number K1 (NO in S68 in FIG. 4), the CPU 32 may add the print job based on the received request to a process queue (S70 in FIG. 4) and perform a print data generation process (S72 in FIG. 4, Y17 in FIG. 6). Here, the process queue may be a queue for sequentially transmitting pieces of print data in response to requests received by the CPU 32.

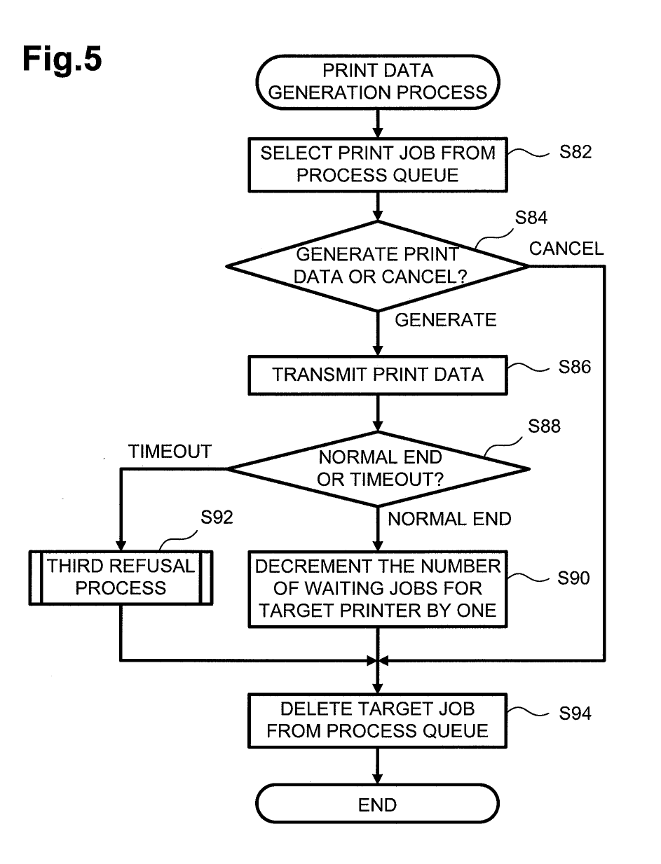

As illustrated in FIG. 5, the CPU 32 may function as the service adding unit 40 that may add a service of “generating print data” in the print data generation process (S72 in FIG. 4), and the CPU 32 may generate print data for a target job. The CPU 32 may select a target job in accordance with the order of print jobs in the process queue (S82 in FIG. 5).

The CPU 32 may generate print data based on the target job selection (“generate” in S84 in FIG. 5). Then, the CPU 32 may function as a transmitting unit 42 and transmit the print data to the PC 10 (S86 in FIG. 5, Y19 in FIG. 6). Accordingly, the PC 10 may receive the print data and transmit the print data to the target printer 50 (Y21 in FIG. 6). That is, the CPU 32 of the server apparatus 30, functioning as the transmitting unit 42, may transmit the generated print data to the target printer 50 via the PC 10.

The CPU 32 may also function as a timing unit (not illustrated) that may measure a transmission time from a time when transmitting unit 42 starts transmission of print data. The CPU 32, acting as the timing unit, may compare the transmission time measured with a specified time L1 stored in the memory 34. If the measured transmission time is within the specified time L1 (normal end in S88 in FIG. 5), the CPU 32 may determine that transmission of the print data has normally ended and may decrement the number of waiting jobs for the target printer 50 by one (S90 in FIG. 5). Alternatively, if the measured transmission time is not within the specified time L1 (timeout in S88 in FIG. 5), the CPU 32 may determine that transmission of the print data has not normally ended. In this case, the CPU 32 may perform a third refusal process (S92 in FIG. 5). In the third refusal process, the CPU 32 may not receive a request from the PC 10 determined as the timeout in S88 for a third period T3. After the process in S90 and S92, the CPU 32 may delete the target job from the process queue (S94 in FIG. 5, Y29 in FIG. 6) and the process may return to S62.

On the other hand, if the user inputs an instruction to cancel generation of print data before generation of print data (“cancel” in S84 in FIG. 5), the CPU 32 may delete the target job from the process queue (S94 in FIG. 5) and the process may return to S62.

3. Abnormality Monitoring Process

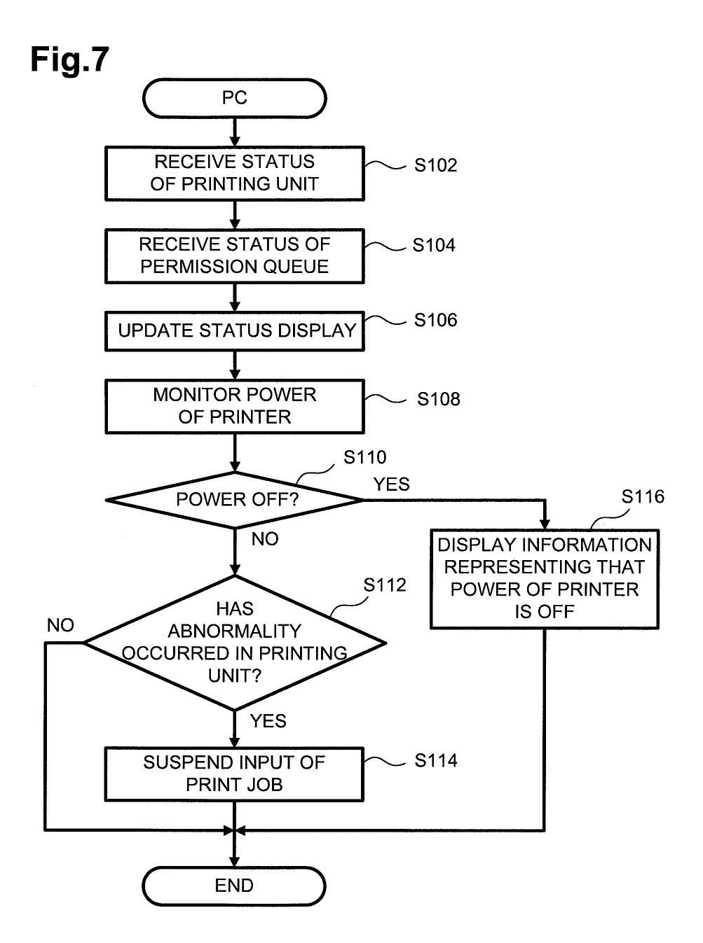

An abnormality monitoring process performed with respect to the printer 50 will be described with reference to FIG. 7. The abnormality monitoring process may be performed at the same time as the above-described printing process, or may be performed at a different time. FIG. 7 illustrates a flowchart of the process performed in the PC 10.

As described above, the CPU 52 of the printer 50 may transmit the status of the printing unit 58 and the status of the print queue to the PCs 10. The CPU 12 of each of the PCs 10 may function as the monitoring unit 24 in the abnormality monitoring process and may display the status of the printer 50 on a display unit (not illustrated). The CPU 12 of the PC 10 may receive the foregoing status while the status of the printer 50 is displayed (S102 and S104) and may, accordingly, update the status display (S106).

If the CPU 12 detects that there is no printing medium in the tray or that there is no coloring agent C in the toner cartridge based on the received status of the printing unit 58, the CPU 12 may display the information about it by updating the display. Also, the CPU 12 may display the number of print jobs included in the print queue and the progress of print data for which an image is currently being printed (e.g., the number of printed pages) by updating the number and progress on the basis of the received status of the print queue.

Subsequently, the CPU 12 may monitor the state of the power of the printer 50 (S108). The CPU 12 may communicate with the printer 50, for example, and may transmit a signal to the printer 50 to request the printer 50 to reply the signal. If no reply is transmitted from the printer 50 to the CPU 12 in response to the signal transmitted from the CPU 12, the CPU 12 may determine that the power of the printer 50 is in an OFF state. Also, the CPU 12 may determine that the power of the printer 50 is in an OFF state if no status is transmitted from the CPU 52 of the printer 50.

If the CPU 12 determines that the power of the printer 50 is in an OFF state (YES in S110), the CPU 12 may display information indicating that the power of the printer 50 is in an OFF state on the display unit, so as to cause the user to turn on the power of the printer 50. Also, the CPU 12 may suspend transmission, to the printer 50, of a request for permission to generate print data until the power of the printer 50 has been turned on (S116). At this time, CPU 12 may also suspend transmission, to the server apparatus 30, of a request to generate print data. If a print job is input by the user during the suspension of transmission of a request for permission to generate print data, the CPU 12 may display an error screen on the display unit.

On the other hand, if the power of the printer 50 is in an ON state (NO in S110), the CPU 12 of the PC 10 may determine whether or not an abnormality has occurred in the printing unit 58 (S112). For example, the CPU 12 may detect an unnatural change in the residual amount of the coloring agent C based on the received status of the printing unit 58 and may identify the abnormality of the printing unit 58 if the change in the residual amount is abnormal, e.g., if the residual amount of the coloring agent C has increased although an image has been printed. If no abnormality has occurred in the printing unit 58 (NO in S112), the CPU 12 may end the process. Alternatively, if an abnormality has occurred in the printing unit 58 (YES in S112), the CPU 12 may display information indicating an abnormality has occurred and may not accept a new print job from a user for a fourth period T4. Accordingly, transmission of a request for permission to generate print data to the printer 50 may be suspended (S114). At this time, transmission of a request for generating print data to the server 30 may also be suspended.

4. Advantages of the Embodiment of FIGS. 1-7

(1) In the printing system according to the embodiment, print data may be generated in the server apparatus 30 for a print job for which generation of print data is permitted in a printing process. Thus, the embodiment may suppress transmission of print jobs to the server apparatus 30 which exceed the allowance of the server apparatus 30 in one period, reducing the processing load on the server apparatus 30.

(2) In the printing system according to the embodiment, the number of print jobs transmitted from the printer 50 to the server apparatus 30 may not exceed the specified number K1 in a printing process. Thus, if more print jobs are transmitted to the server apparatus 30, an excessive transmission of print jobs which increases the load on the server apparatus 30 (e.g., a cyberattack) or an excessive transmission of permission to generate print data resulting from toggling the power of the printer 50 between OFF/ON may have occurred. In the printing system of the embodiment, a refusal process may be performed if a number of a print jobs larger than the specified number K1 is transmitted to the server apparatus 30, such that the refusal process protects the server apparatus 30 against the foregoing abnormalities.

Among the abnormalities that may occur in the server apparatus 30, excessive transmission of permission to generate print data may be easily overcome because the number of print jobs accumulated in the server apparatus 30 may be relatively small in many cases. Thus, excessive transmission of permission to generate print data may be overcome by printing the print jobs accumulated in the server apparatus 30, in these cases. With respect to the cyberattack, however, the number of print jobs accumulated in the server apparatus 30 may continuously increase as long as excessive transmission continues. To overcome the cyberattack, it may be necessary to take different measures from those taken to overcome temporary accumulation of print jobs. In the printing system according to the embodiment, if an abnormality occurs in the server apparatus 30, the abnormality may be classified using the specified number K2 and a refusal process may be performed in accordance with the classification. Thus, appropriate measures may be taken against each type of abnormality.

(3) In the printing system according to the embodiment, if a user cancels an unprinted print job in a printing process, the printer 50 may receive a cancel signal, delete the target job from a print queue, and renew the print orders in the print queue. Accordingly, even if the user cancels an unprinted print job, the print jobs included in the print queue may be properly managed.

(4) In the printing system according to the embodiment, if the PC 10 cannot transmit a print job to the server apparatus 30 in a printing process, the PC 10 may transmit a cancel signal to the printer 50. The printer 50 may then receive the cancel signal and may perform the foregoing cancellation process. In the printing process, the PC 10 may not be able to transmit a print job to the server apparatus 30 due to downtime or an abnormality in the server apparatus 30. In such a case, the PC 10 of the embodiment may cancel the print job even if the user does not cancel the print job, such that unnecessary repetition of a print job transmission process performed by the PC 10 may be suppressed.

(5) In the printing system according to the embodiment, the PC 10 may comprise a monitoring function that monitors whether or not the printing unit 58 of the printer 50 has an abnormality. In the printing system, the server apparatus 30 may be connected to a plurality of PCs in many cases. Some of the PCs 10 connected to the server apparatus 30 may be intentionally connected to a fake printer having an abnormality for the purpose of increasing a load on the server apparatus 30 by increasing the number of printers that may print the print data generated by the server apparatus 30 (another example of a cyberattack). In the printing system according to the embodiment, the monitoring function provided in the PC 10 may prevent a print job associated with the printer 50 that has an abnormality from being transmitted to the server apparatus 30, such that an increase in the load on the server apparatus 30 may be suppressed.

If the printing unit 58 has an abnormality, printing may not be performed and the residual amount of the coloring agent C in the printing unit 58 may not change in many such cases. In the printing system according to the embodiment, an abnormality in the printing unit 58 may be efficiently detected where the PC 10 monitors the printing unit 58 to determine whether or not the residual amount of the coloring agent C abnormally changes. Further, monitoring printing unit 58 to determine whether or not the residual amount of the coloring agent C abnormally changes may be more efficient than monitoring whether or not other abnormalities occur

### Another Embodiment

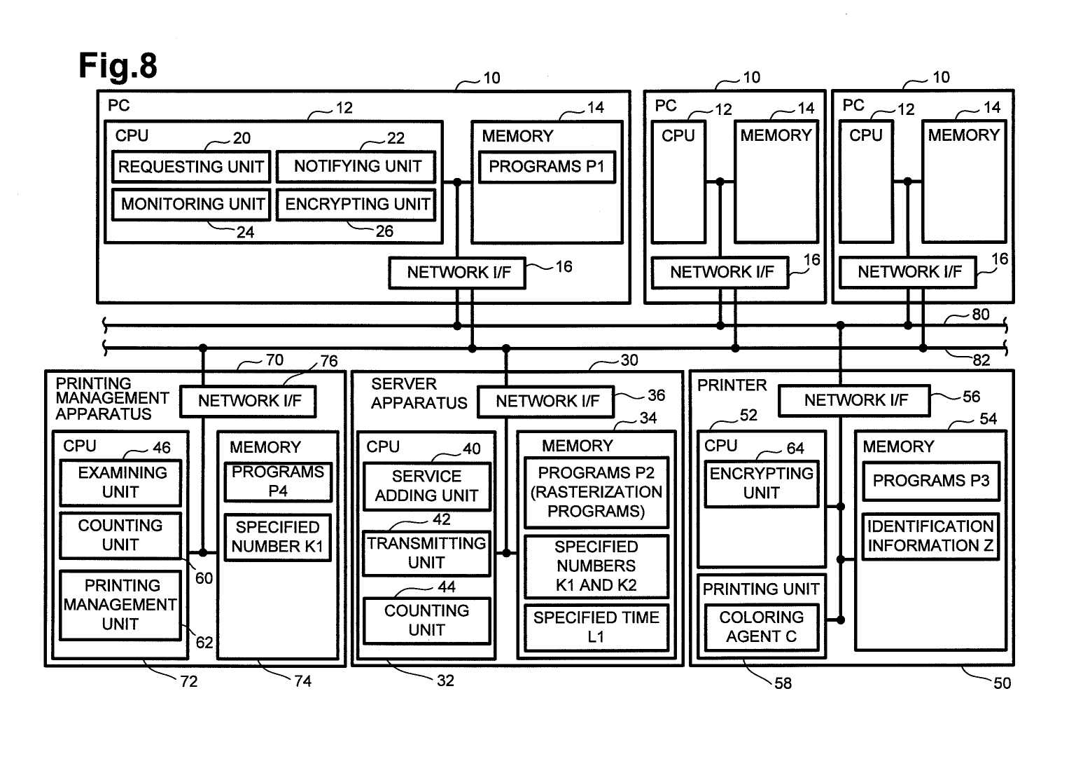

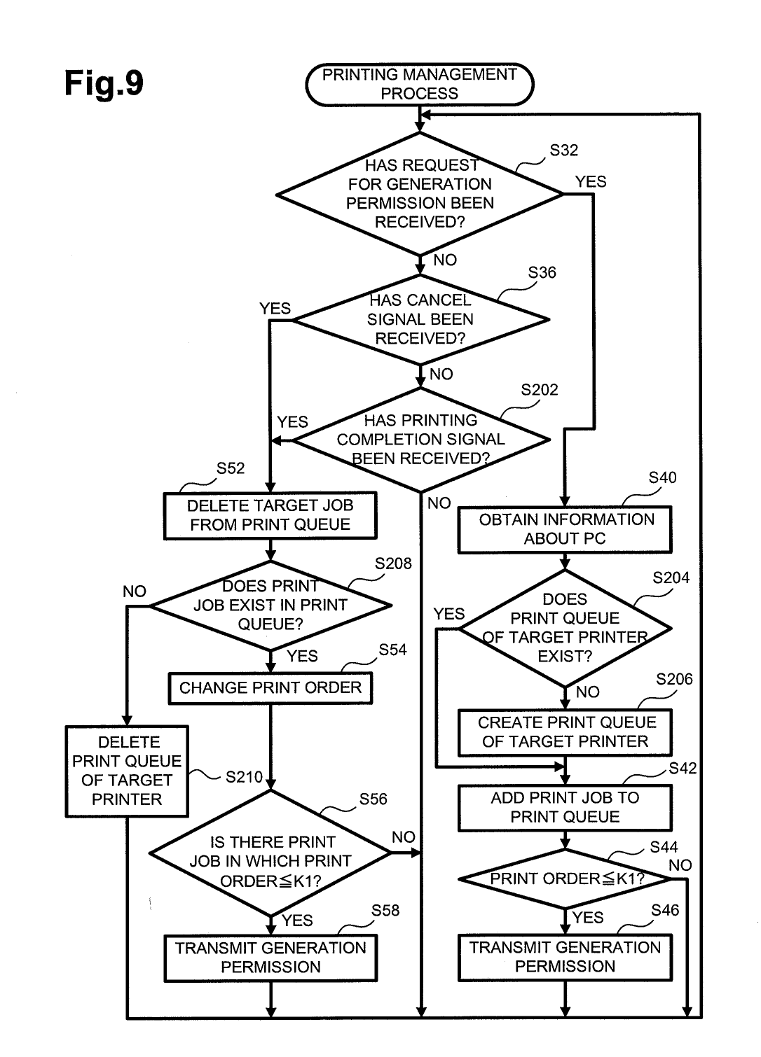

Another embodiment will be described with reference to FIGS. 8 and 9. As illustrated in FIG. 8, the system according to this embodiment may be different from the system according to the embodiment in that a printing management apparatus 70 may be provided separately from the server apparatus 30 and the printer 50. The printing management apparatus 70 may perform the processes that are performed in the examining unit 46, the counting unit 60, and the printing management unit 62 according to the embodiment. In the following description, descriptions of the features that are the same or similar to those described in the embodiment above will be omitted.

Configuration of System

The printing management apparatus 70 may comprise a CPU 72, a memory 74, and a network interface 76.

The memory 74 may store a plurality of programs P4. In accordance with the programs P4 read from the memory 74, the CPU 72 may function as the examining unit 46, the counting unit 60, the printing management unit 62, and the like; may control the printing management apparatus 70; and may also control communication with the PCs 10 and so forth. The individual units included in the printing management apparatus 70 according to this embodiment may have substantially the same functions as the units having the same names and denoted by the same reference numerals in the embodiment. Accordingly, the corresponding description of these units with respect to this embodiment will be omitted.

The network interface 76 may be connected to the communication line 82 of the WAN to which the PCs 10 and the server apparatus 30 are connected. The network interface 76 may perform data communication and input/output of a process request with the PCs 10.

The printing management apparatus 70 may manage print jobs of all the printers 50 connected thereto using the communication lines of the LAN and WAN. The printing management apparatus 70 may be separated from or integrated with the server apparatus 30.

Alternatively, a plurality of printing management apparatuses 70 may exist for the server apparatus 30. In that case, the individual printing management apparatuses 70 may be connected to the communication line 80 included in the LAN to which the PCs 10 and the printers 50 are connected, and the printing management apparatuses 70 may be connected via an appropriate apparatus to the communication line 82 comprised in the WAN.

2. Printing Process

The processes performed by the individual apparatuses in the printing process according to this embodiment will be described. The PC 10 may perform the same process as the printing process according to the embodiment of FIGS. 1-7 except that the PC 10 may transmit a request to the printing management apparatus 70 for permission to generate print data in S6 (FIG. 2) and may transmit a cancel signal to the printing management apparatus 70 in S22 (FIG. 2). The printer 50 may perform a printing process (S34, S48, and S50 in FIG. 3). In S50, the printer 50 may transmit a printing completion signal to the printing management apparatus 70. The server apparatus 30 of this embodiment may perform the same process described with respect to the embodiment.

FIG. 9 illustrates the process performed by the printing management apparatus 70 in the printing process. In the printing process according to this embodiment, the printing management apparatus 70 may substantially perform the process described with respect to the embodiment except for the steps S34, S48, and S50 depicted in FIG. 3. Since the printing management apparatus 70 itself may not perform the printing process, the printing management apparatus 70 may determine whether or not the printing management apparatus 70 has received a printing completion signal from the printer 50 (S202) and may perform the process from S52 if the printing management apparatus 70 has received a printing completion signal (YES in S202). If the printing management apparatus 70 has not received a printing completion signal (NO in S202), the process may return to S32. Also, the printing management apparatus 70 may manage print jobs of the printers 50 connected thereto using the communication lines of the LAN and WAN. Thus, the following process is added accordingly.

The CPU 72 of the printing management apparatus 70 may obtain the information about the PC 10 (S40) based on a request for permission to generate print data from the PC 10 (YES in S32) and then may determine whether or not a print queue of the target printer 50 exists (S204). If the print queue of the target printer 50 exists (YES in S204), the CPU 72 may add the print job to the print queue based on the received request (S42). On the other hand, if the print queue of the target printer 50 does not exist (NO in S204), the CPU 72 may newly create a print queue of the target printer 50 (S206) and add the print job to the created print queue based on the received request (S42).

Also, the CPU 72 may delete the target job from the print queue (S52) based on a cancel signal or a printing completion signal received from the PC 10 (YES in S36 or S202) and may then determine whether or not a print job exists in the print queue of the target printer 50 (S208). If a print job exists in the print queue of the target printer 50 (YES in S208), the CPU 72 may perform the process from S54 through S58. Alternatively, if no print job exists in the print queue of the target printer 50 (NO in S208), the CPU 72 may delete the print queue (S210). Accordingly, the above-described deletion process may suppress an increase in processing load of the printing management apparatus 70 caused by loading from the print queue of the printer 50 to which no print job is currently input.

3. Advantages of the Embodiment of FIGS. 8 and 9

(1) In the printing system according to the embodiment of FIGS. 8 and 9, the server apparatus 30 may generate print data for a print job for which generation of print data is permitted by the printing management apparatus in a printing process. Thus, this embodiment may suppress transmission of print jobs to the server apparatus 30 which exceed the allowance of the server apparatus 30 in one period, reducing the processing load on the server apparatus 30. Also, providing the printing management apparatus 70 separately from the printer 50 may eliminate the necessity of determining whether or not generation of print data may be permitted in the printer 50, additionally reducing the processing load on the printer 50.

(2) The printer 50 according to the embodiment of FIGS. 1-7 may be a dedicated printer including the printing management unit 62. In contrast, the printer 50 according to this embodiment may not require the printing management unit 62. Thus, the system may be easily configured using a commercially available printer.

### Still Another Embodiment

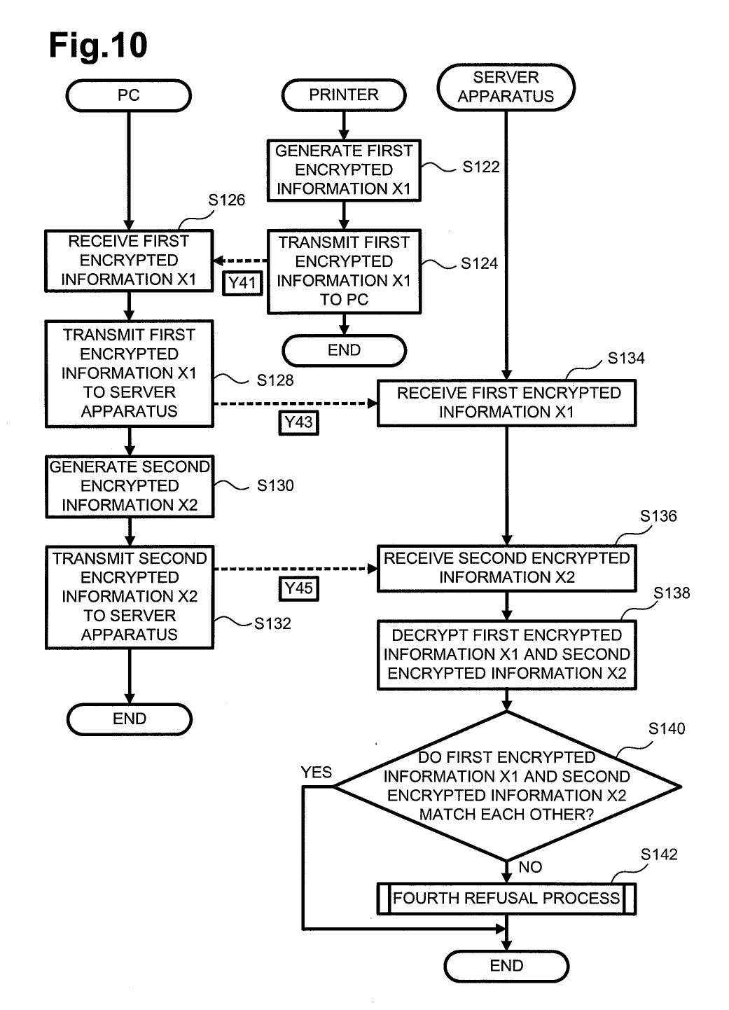

Still another embodiment will be described with reference to FIG. 10.

According to the above-mentioned embodiment, the number of requests for a printing service transmitted to the server apparatus 30 may be limited to a number equal to or less than the product of the number of operated printers 50 and the specified number K1.

However, there is a possibility that the server apparatus 30 may encounter a cyberattack in which the program executed in the PC 10 (client printer driver or the like) and the operation of the printer 50 may be emulated using a malicious program in such a manner that as if the printer 50 is operating although the printer 50 is not actually operating. Such a cyberattack may be eliminated by using an authentication process described below.

1. Authentication Process

An authentication process performed among the PC 10, the server apparatus 30, and the printer 50 will be described with reference to FIGS. 1 and 10. This encryption process may be performed at the same time as the above-described printing process and an abnormality monitoring process, or the encryption process may be performed at different time. FIG. 10 illustrates a flowchart of a process performed in the individual apparatuses.

As illustrated in FIG. 1, identification information Z may be stored in the memory 54 of the printer 50. The CPU 52 of the printer 50 may function as the encrypting unit 64 in the authentication process. Accordingly, the CPU 52 may encrypt the identification information Z using a first encryption scheme to generate first encrypted information X1 (S122) and may transmit the first encrypted information X1 to the PC 10 (S124, Y41).

The programs P3 that support a plurality of encryption schemes may be stored in the memory 54 of the printer 50. The CPU 52 of the printer 50 may encrypt the identification information Z using an encryption scheme selected from among the plurality of encryption schemes. The CPU 52 may change the encryption scheme used as the first encryption scheme every time a reference period T5 elapses, thereby preventing encryption in the first encryption scheme from being invalidated.

The CPU 12 of the PC 10 may receive the first encrypted information X1 (S126), may then temporarily store the first encrypted information X1 in the memory 14, and may also transmit the first encrypted information X1 to the server apparatus 30 (S128, Y43). In addition, the CPU 12 may function as the encrypting unit 26 to further encrypt the first encrypted information X1 using a second encryption scheme, thereby generating second encrypted information X2 (S130). The CPU 12 may then transmit the second encrypted information X2 to the server apparatus 30 (S132, Y45).

The programs P1 corresponding to a plurality of encryption schemes may be stored in the memory 14 of the PC 10. The CPU 12 of the PC 10 may encrypt the first encrypted information X1 using an encryption scheme selected from among the plurality of encryption schemes. The CPU 12 may change the encryption scheme used as the second encryption scheme every time a reference period T6 elapses, thereby preventing invalidation of the encryption in the first encryption scheme.

The CPU 32 of the server apparatus 30 may receive the first encrypted information X1 and the second encrypted information X2 (S134 and S136). Then, the CPU 32 may decrypt the first encrypted information X1 and the second encrypted information X2 (S138) to generate first decrypted information H1 from the first encrypted information X1 and second decrypted information H2 from the second encrypted information X2.

The programs P2 corresponding to a plurality of decryption schemes based on the first encryption scheme and the second encryption scheme of the PC 10 and the printer 50 that are authenticated in advance by the server apparatus 30 may be stored in the memory 34 of the server apparatus 30. The CPU 32 may decrypt the first encrypted information X1 and the second encrypted information X2 using these decryption schemes.

As described above, the encryption schemes used as the first encryption scheme and the second encryption scheme may be changed at certain timing. The memory 34 of the server apparatus 30 may store the order and timing of changing the encryption schemes used by the PC 10 and the printer 50 authenticated in advance by the server apparatus 30. The CPU 32 selects an appropriate decryption scheme from among the plurality of decryption schemes based on the time the server apparatus 32 receives the first encrypted information X1 and the time the server apparatus 32 receives the second encrypted information X2, and decrypts the first encrypted information X1 and the second encrypted information X2.

Subsequently, the CPU 32 may function as the examining unit 46 and may compare the first decrypted information H1 with the second decrypted information H2 (S140). Here, if at least one of the first decrypted information H1 and the second decrypted information H2 comprises a plurality of pieces of decrypted information, the CPU 32 may compare each of the plurality of pieces of decrypted information. If the first decrypted information H1 and the second decrypted information H2 match each other (YES in S140), the CPU 32 may determine that the PC 10 and printer 50 which generated the first encrypted information X1 and the second encrypted information X2 are authenticated and may end the process.

Alternatively, if the first decrypted information H1 and the second decrypted information H2 do not match each other (NO in S140), the CPU 32 may determine that the PC 10 and printer 50 that have generated the first encrypted information X1 and the second encrypted information X2 comprise at least one of an unauthenticated PC 10 and an unauthenticated printer 50. The CPU 32 may then perform a fourth refusal process (S142). In the fourth refusal process, the CPU 32 may store the information about the unauthenticated PC 10 and the unauthenticated printer 50 in the memory 34 and may not accept a request from the unauthenticated PC 10 for a seventh period T7. Also, the CPU 32 may not accept a request to generate print data to the unauthenticated printer 50 for the seventh period T7.

The PC 10, the server apparatus 30, and the printer 50 may be normally set to the same time, but a slight time lag may occur among them. Also, since the CPU 32 of the server apparatus 30 receives pieces of encrypted information X generated by the PC 10 and the printer 50 through the communication line 80, a time lag may occur between the time when the PC 10 and the printer 50 generate these pieces of encrypted information X and the time when the server apparatus 30 receives these pieces of encrypted information X.

For this reason, 5138 and 5140 are separately illustrated in FIG. 10 for convenience. However, if it is determined in S140 that the first decrypted information H1 and the second decrypted information H2 information do not match each other, a retry process may be performed in which decryption at a certain past time is performed and re-comparison is performed on the past time decrypted information. The decryption scheme for decrypting the above-described first and second encrypted information may be a private scheme.

2. Advantages of the Embodiment of FIG. 10

(1) In the printing system according to the embodiment of FIG. 10, the first encrypted information X1 generated by the printer 50 and the second encrypted information X2 generated by the PC 10 may be decrypted by the server apparatus 30, and the printer 50 and the PC 10 may be verified using the decrypted information in the authentication process. The server apparatus 30 may authenticate these apparatuses in advance, and may decrypt the information when the server apparatus 30 knows the encryption scheme. That is, whether or not the printer 50 and the PC 10 are safe apparatuses that have been authenticated in advance may be determined by determining whether or not the server apparatus 30 may decrypt the information. In the printing system according to the embodiment of FIG. 10, the server apparatus 30 may be protected against a cyberattack from an apparatus that has not been authenticated as a safe apparatus.

(2) Also, in the printing system according to the embodiment of FIG. 10, authentication may be performed among the PC 10, the printer 50, and the server apparatus 30; and the encryption scheme used thereby may change with time by performing the above-described process. Therefore, mis-authentication may be prevented even if packets on a network are captured and copied.

### Yet Another Embodiment

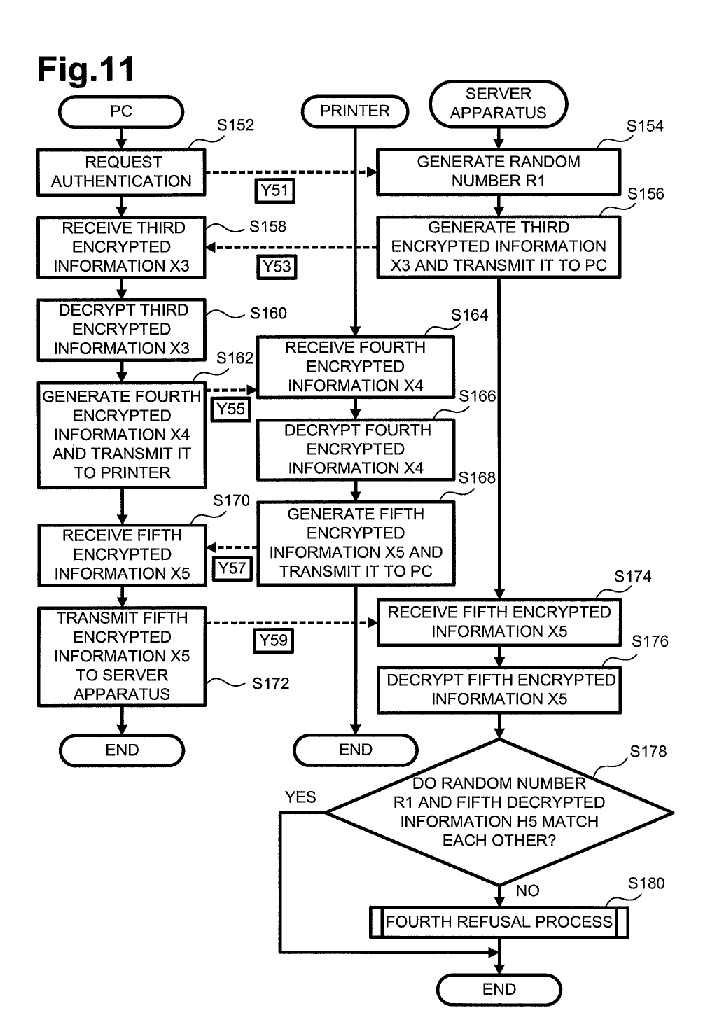

Yet another embodiment will be described with reference to FIGS. 1 and 11. As illustrated in FIG. 11, the authentication process performed in the system according to this embodiment may be different from the authentication process performed in the system according to the embodiment of FIG. 10. In the following description, descriptions of the features that are the same or similar to those described in the embodiment of FIG. 10 above will be omitted.

Configuration of System

In the system according to this embodiment, compared to the embodiment of FIG. 10, additional programs P2 may be stored in the memory 34 of the server apparatus 30, such that the CPU 32 of the server apparatus 30 may further function as an encrypting unit 48 and a random number generating unit 49, which are represented by broken lines in FIG. 1. Also, the identification information Z, which may be stored in the memory 54 of the printer 50 in the embodiment, may not be required in this embodiment.

2. Authentication Process

As illustrated in FIG. 11, upon the start of an authentication process in this system, the CPU 12 of the PC may request the server apparatus 30 to perform authentication (S152, Y51). The CPU 32 of the server apparatus 30 may receive the request (S154) and may function as a random number generating unit 49. Accordingly, the CPU 32 may generate a random number R1 and may temporarily store the random number R1 in the memory 34. The CPU 32 may encrypt the generated random number R1 using a third encryption scheme to generate third encrypted information X3 and may transmit the third encrypted information X3 to the PC 10 (S156, Y53).

The CPU 12 of the PC 10 may receive the third encrypted information X3 (S158), and then may decrypt the third encrypted information X3 (S160) to generate third decrypted information H3. Subsequently, the CPU 12 may encrypt the generated third decrypted information H3 using a fourth encryption scheme to generate fourth encrypted information X4 and may transmit the fourth encrypted information X4 to the printer 50 (S162, Y55).

The CPU 52 of the printer 50 may receive the fourth encrypted information X4 (S164) and then may decrypt the fourth encrypted information X4 to generate fourth decrypted information H4. Subsequently, the CPU 52 may encrypt the generated fourth decrypted information H4 using a fifth encryption scheme to generate fifth encrypted information X5 and may transmit the fifth encrypted information X5 to the PC 10 (S168, Y57).

The CPU 12 of the PC 10 may receive the fifth encrypted information X5 (S170) and then may transmit the fifth encrypted information X5 to the server apparatus 30 (S172, Y59). The CPU 32 of the server apparatus 30 may receive the fifth encrypted information X5 (S174) and then may decrypt the fifth encrypted information X5 (S176) to generate fifth decrypted information H5.

Subsequently, the CPU 32 may compare the random number R1 with the fifth decrypted information H5 (S178). If the random number R1 and the fifth decrypted information H5 match each other (YES in S178), the CPU 32 may determine that the PC 10 and the printer 50 that have generated the fourth encrypted information X4 and the fifth encrypted information X5 are authenticated and may end the process.

On the other hand, if the random number R1 and the fifth decrypted information H5 do not match each other (NO in S178), the CPU 32 may determine that the PC 10 and the printer 50 that have generated the fourth encrypted information X4 and the fifth encrypted information X5 include at least one of an unauthenticated PC 10 and an unauthenticated printer 50. The CPU 32 may then perform a fourth refusal process (S180).

3. Advantages of the Embodiment of FIG. 11

(1) In the printing system according to the embodiment of FIG. 11, the fifth encrypted information X5 that is generated through the encryption process in the printer 50 and the encryption process in the PC 10 may be decrypted by the server apparatus 30, and the printer 50 and the PC 10 may be verified in the authentication process using the decrypted information. The server apparatus 30 may authenticate these apparatuses in advance and may decrypt the information when the server apparatus 30 knows the encryption scheme. That is, whether or not the printer and the PC 10 are safe apparatuses that have been authenticated in advance may be determined by determining whether or not the server apparatus 30 is able to decrypt the information. In the printing system according to the embodiment of FIG. 11, the server apparatus 30 may be protected against a cyberattack from an apparatus that has not been authenticated as a safe apparatus.

### Other Embodiments

The present invention is not limited to the embodiments described above with reference to the drawings. For example, the technical scope of the present invention comprises, but is not limited to, the following embodiments and features.

According to the above-described embodiments, if the number of waiting jobs for the target printer 50 is larger than the specified number K1, the server apparatus 30 may further compare the number of waiting jobs with the specified number K2. However, it may not be necessary to compare the number of waiting jobs with the specified number K2. If server apparatus 30 determines that the number of waiting jobs for the target printer 50 is larger than the specified number K1 and that an abnormality has occurred, the server apparatus 30 may not compare the number of waiting jobs for the target printer 50 with the specified number K2, and the server apparatus 30 does not accept a print job from the PC 10. In this manner, the server apparatus 30 may be protected from an abnormality.

(2) According to the above-described embodiments, comparison of decrypted information H may be performed once in the authentication process. Alternatively, comparison of decrypted information H may be performed a plurality of times. In this case, there may be a plurality of pieces of decrypted information H based on the same information encrypted by the same apparatus. Thus, the plurality of pieces of decrypted information H based on the same information encrypted by the same apparatus may be compared with each other.

(3) According to the above-described embodiments, a verification process may be performed in the server apparatus 30 during the authentication process. If the printing system comprises the printing management apparatus 70 separated from the server apparatus 30, as illustrated in FIG. 8, the CPU 72 of the printing management apparatus 70 may function as the examining unit 46 to perform the verification process in the printing management apparatus 70. Accordingly, it may not be necessary for the server apparatus 30 to perform an authentication process, and the processing load on the server apparatus 30 may be reduced.

(4) According to the above-described embodiments, the single CPU 12 may function as the requesting unit 20, the notifying unit 22, and the like, but the present invention is not limited to this arrangement. For example, distinct CPUs or other circuits may constitute each of these units. Distinct CPUs or other circuits may constitute one or more of the service adding unit 40, the transmitting unit 42, the counting unit 60, the printing management unit 62, and the like.

(5) According to the above-described embodiments, the server apparatus 30 may transmit generated print data to the printer 50 via the PC 10. Alternatively, the server apparatus 30 may directly transmit the print data to the printer 50. In such a case, the network interface 56 of the printer 50 may be connected to the communication line 82 of the WAN to which the server apparatus 30 is connected, and the printer 50 may perform data communication and input/output of a process request with the server apparatus 30.

While the invention has been described in connection with various example structures and illustrative embodiments, it will be understood by those skilled in the art that other variations and modifications of the structures and embodiments described above may be made without departing from the scope of the invention. Other structures and embodiments will be apparent to those skilled in the art from a consideration of the specification or practice of the invention disclosed herein. It is intended that the specification and the described examples are illustrative with the true scope of the invention being defined by the following claims.

What is claimed is:

1. A printing system comprising:
a client;
at least one printer;
a server; and
wherein the client is configured to transmit a permission request to the management device,
wherein, the management device is configured to determine a number of jobs in a print queue, calculate a comparison value by adding one to the number of jobs in the print queue, and compare a predetermined value to the comparison value upon receipt of the permission request,
wherein, the management device is configured to transmit a utilization permission to the client when the comparison value is less than or equal to the predetermined value, and
wherein, the client is configured to transmit a job comprising image data to the server when the client receives the utilization permission, and the server is configured to generate printing data based on the image data when the server receives the job and to transmit the printing data to the at least one printer.

2. The printing system according to claim 1, wherein the printer comprises the management device.

3. The printing system according to claim 1,
wherein the management device further comprises a counter configured to assign an ordinal to each job for one of the at least one printer.

4. The printing system according to claim 3,
wherein the management device is configured to assign a higher ordinal to at least one job in response to a request from the client.

5. The printing system according to claim 1,
wherein the server is configured to determine a number of jobs in the server, calculate another comparison value by adding one to the number of jobs in the server, and compare the predetermined value to the other comparison value upon receipt of the job from the client,
wherein the server is configured to prevent generation of the printing data when the other comparison value is greater than the predetermined value,
wherein the job comprises the printing data after the server generates the printing data, and
wherein the number of jobs in the server corresponds to a quantity of jobs received in the server from the client and that comprise printing data that has not been printed by the printer before the management device determines the number of jobs in the print queue.

6. The printing system according to claim 5,
wherein, when the other comparison value is equal to or less than another predetermined value, which is greater than the predetermined value, the server is configured to prevent receipt of the job for a first period,
wherein, when the other comparison value is greater than the other predetermined value, the server is configured to prevent receipt of the job for a second period, and
wherein the second period is longer than the first period.

7. The printing system according to claim 1,
wherein the client is configured to transmit a cancellation notification to the management device when the print job is cancelled after the client transmits the permission request to the management device, and
wherein the management device is configured to re-determine the number of jobs in the print queue by subtracting one from the previously determined number of jobs in the print queue when the management device receives the cancellation notification from the client.

8. The printing system according to claim 1,
wherein the client is configured to transmit a cancellation notification to the management device when an abnormality prevents the client from transmitting the job to the server, and
wherein the management device is configured to re-determine the number of jobs in the print queue by subtracting one from the previously determined number of jobs in the print queue when the management device receives the cancellation notification from the client.

9. The printing system according to claim 1,
wherein the client is configured to determine whether or not the printer has an abnormality, and
wherein the client is configured to suspend transmission of the job to the server when the client determines that the printer has an abnormality.

10. The printing system according to claim 9, wherein the client is configured to monitor a residual amount of a coloring agent in the printer and to determine that the printer has an abnormality when a change in the residual amount of the coloring agent is abnormal.

11. The printing system according to claim 1,
wherein the client comprises a first encrypting unit configured to prepare first encrypted data by encrypting particular data using a first encryption scheme,
wherein the printer comprises a second encrypting unit configured to prepare second encrypted data by encrypting the particular data using a second encryption scheme,
wherein the client is configured to transmit the first encrypted data to the server,
wherein the printer is configured to transmit the second encrypted data to the server,
wherein, when the server receives the first encrypted data and the second encrypted data, the server is configured to generate first decrypted data by decrypting the first encrypted data and to generate second decrypted data by decrypting the second encrypted data,
wherein the server is configured to compare the first decrypted data with the second decrypted data,
wherein the server is configured to determine that the client and the printer are authenticated when the first decrypted data and the second decrypted data match, and
wherein the server is configured to determine that at least one of the client and the printer is unauthenticated when the first decrypted data and the second decrypted data do not match.

12. The printing system according to claim 1,
wherein the client is configured to transmit an authentication request to the server,
wherein, when the server receives the authentication request from the client, the server is configured to generate a random number, to prepare first encrypted data by encrypting the random number, and to transmit the first encrypted data to the client,
wherein, when the client receives the first encrypted data from the server, the client is configured to prepare first decrypted data by decrypting the first encrypted data,
wherein the client is configured to prepare second encrypted data by encrypting the first encrypted data and to send the second encrypted data to the printer,
wherein, when the printer receives the second encrypted data from the client, the printer is configured to prepare second decrypted data by decrypting the second encrypted data,
wherein the printer is configured to prepare third encrypted data by encrypting the second decrypted data and to transmit the third encrypted data to the client,
wherein, when the client receives the third encrypted data from the printer, the client is configured to transmit the third encrypted data to the server,
wherein, when the server receives the third encrypted data from the client, the server is configured to prepare third decrypted data by decrypting the third encrypted data and to compare the third decrypted data with the random number,
wherein the server is configured to determine that the client and the printer are authenticated when the third decrypted data is the random number, and
wherein the server is configured to determine that at least one of the client and the printer is unauthenticated when the third decrypted data is not the random number.

13. A method of managing a printing process, comprising the steps of:
transmitting a permission request from a client to a management device,
determining a number of print jobs in a print queue;
calculating a comparison value by adding one to the number of print jobs in the print queue;
comparing a predetermined value to the comparison value;
transmitting a utilization permission from the management device to the client when the comparison value is less than or equal to the predetermined value;
transmitting a job comprising image data from the client to a server when the client receives the utilization permission from the management device;
generating printing data in the server based on the image data when the server receives the job from the client;
transmitting the printing data from the server to a printer; and
printing the printing data.

14. A non-transitory, computer-readable medium comprising operating instructions to perform the steps of:
receiving a permission request from a client;
determining a number of print jobs in a print queue;
calculating a comparison value by adding one to the number of print jobs in the print queue;
comparing a predetermined value to the comparison value; and
transmitting a utilization permission to the client when the comparison value is less than or equal to the predetermined value to permit the client to transmit a job to a server.

15. The non-transitory, computer-readable medium according to claim 14, further comprising operating instructions to perform the steps of:
receiving a cancellation notification from the client when a print job is cancelled after receipt of a permission request from the client; and
re-determining the number of jobs in the print queue by subtracting one from the previously determined number of jobs in the print queue.

16. The non-transitory, computer-readable medium according to claim 14, further comprising operating instructions to perform the steps of:
receiving a cancellation notification from the client when an abnormality prevents the client from transmitting a print job to the server; and
re-determining the number of jobs in the print queue by subtracting one from the previously determined number of jobs in the print queue.

17. The non-transitory, computer-readable medium according to claim 14, further comprising operating instructions to perform the steps of:
receiving first encrypted data from the client;
receiving second encrypted data from a printer;
generating first decrypted data by decrypting the first encrypted data and generating second decrypted data by decrypting the second encrypted data;
comparing the first decrypted data to the second decrypted data;
determining that the client and the printer are authenticated when the first decrypted data matches the second decrypted data; and
determining that at least one of the client and the printer is unauthenticated when the first decrypted data does not match the second decrypted data.

18. A management device comprising:
a receiver configured to receive a permission request from a client;
a counter configured to determine a number of print jobs in a print queue;
a calculator configured to calculate a comparison value by adding one to the number of print jobs in the print queue;
a comparator configured to compare a predetermined value to the comparison value; and
a transmitting device configured to transmit a utilization permission to a client when the comparison value is less than or equal to the predetermined value to permit the client to transmit a job to a server.

19. The management device according to claim 18,
wherein the receiver is configured to receive a cancellation notification from the client when a print job is cancelled after receipt of a permission request from the client; and
wherein the counter is configured to re-determine the number of jobs in the print queue by subtracting one from the previously determined number of jobs in the print queue.

20. The management device according to claim 18,
wherein the receiver is configured to receive a cancellation notification from the client when an abnormality prevents the client from transmitting a print job to the server; and
wherein the counter is configured to re-determine the number of jobs in the print queue by subtracting one from the previously determined number of jobs in the print queue.

21. The management device according to claim 18, further comprising:
a decrypting unit,
wherein the receiver is configured to receive first encrypted data from the client and second encrypted data from a printer,
wherein the decrypting unit is configured to generate first decrypted data by decrypting the first encrypted data and generating second decrypted data by decrypting the second encrypted data, and
wherein the decrypting unit is configured to compare the first decrypted data to the second decrypted data; and when the first decrypted data matches the second decrypted data, the management device authenticates the client and printer; and when the first decrypted data does not match the second decrypted data, at least one of the client and the printer is unauthenticated.
